(19) United States
(12) Patent Application Publication
(10) Pub. No.: US 2005/0070190 A1
(43) Pub. Date: Mar. 31, 2005

(54) Compound fabric for making protective cover

(75) Inventor: Ming-Shun Yang, Taipei (TW)

Correspondence Address: BRUCE H. TROXELL;SUITE 1404, 5205 LEESBURG PIKE, FALLS CHURCH, VA, 22041, US

(73) Assignee: FORMOSA SAINT JOSE CORPORATION

(21) Appl. No.: 10/673,412

(22) Filed: Sep. 30, 2003

(51) Int. Cl. B32B 31/20; B32B 5/26

(52) U.S. Cl. 442/268; 442/277; 442/278; 442/319; 442/381

(57) ABSTRACT

A compound fabric for making protective cover includes at least three layers of fabrics, namely, upper and lower layer that are waterproof and air-permeable non-woven fabrics made of polypropylene, or polyethylene, or polyester fibers, and the middle layer that is a woven or knitted fabric specially treated to have waterproof and air-permeable properties. The non-woen upper and lower layers enable the compound fabric to be pliable, solid, thick, and tough, and the woven middle layer enables the compound fabric to have largely enhanced tensile strength and tear strength, so that a protective cover made of the compound fabric is not only tough and pliable but also waterproof and air-permeable to provide good protective effect.

### FIELD OF THE INVENTION

The present invention relates to a compound fabric for making protective cover, and more particularly to a compound fabric that is tough, pliable, waterproof, and air-permeable, therefore very suitable for making a protective cover for vehicle.

### BACKGROUND OF THE INVENTION

Generally, a vehicle, such as motorcycle, car, yacht, water motorcycle, etc., that is not in use is normally covered with a protective cover having a configuration matching with that of the vehicle, so that the vehicle is protected against dust, sunray, and rainwater, as well as direct impact by foreign matters. The protective cover also protects a vehicle parked outdoors or being trailed by a trailer against dust, rainwater, snow, moisture, and impact by foreign matters.

It is possible some parts of vehicle, particularly an engine, would have a residual heat once the engine has been started. The protective cover covering the vehicle may also trap such as residual heat or moisture inside the cover. It is necessary to remove the residual heat and moisture from inside of the protective cover to avoid detrimental effects on various parts and surface paint of the vehicle by such trapped residual heat and moisture. Therefore, the protective cover for vehicle must be made of a material that is not only waterproof but also air-permeable to allow the heat and moisture emit outside. On the other hand, when a vehicle, such as a yacht, is trailed by trailer, for example, from a garage to a lake, riverside, or seashore for use, the protective cover covering the yacht is subject to wind resistance that applies a very strong pulling and tearing force on the protective cover when the trailer moves on highway at a high speed. Therefore, the protective cover must also have enhanced tensile strength and tear strength for being used safely even under high speed moving environment.

The above-mentioned protective cover for vehicle is generally made of a non-woven cloth, which is produced by forming filaments from molten polypropylene, or polyethylene, or polyester and pressing the produced filaments with rollers. The non-woven cloth has the advantage of being pliable, air-permeable, water-repellent, and lightweight, and may therefore be used to make a protective covers that is suitable for use under a static working environment to protect a vehicle against dust, water, and foreign matters. However, the non-woven cloth has tensile strength and tear strength much lower than that of general woven fabric, and is therefore not suitable for making a protective cover for use on a vehicle moving at a high speed.

A non-woven cloth having only one single layer of material is relatively thin, subject to relatively light protecting, with low anti-impact ability and less durability. Thus a compound non-woven cloth having more than one layer of material has been developed. FIG. 1 illustrates conventional compound non-woven clothes (1) having four layers of materials (11), (12), (13), and (14) for making protective cover, and FIG. 2 is a sectional view of the compound non-woven cloth (1) of FIG. 1. The four layers of materials (11), (12), (13), and (14) are bonded together by way of ultrasonic welding. The middle layer (12) or (13) may be a melting blown non-woven cloth having relatively good air permeability and water tightness, while the outer layers (11) and (14) are spun-bonded non-woven fabric. Although the layers (11), (12), (13), and (14) provide the compound non-woven cloth (1) with improved tensile and tear strength as compare with the conventional one-year non-woven clcoth, the tensile strength and the tear strength of the compound non-woven cloth (1) is still lower than those general woven fabrics can achieve for marking protective covers. That is, although the cocmpound non-woven cloth (1) is sufficiently solid, thick, better waterproof, and air-permeable, it is suitable for making a protective cover for use only in a still environment. More specifically, the compound non-woven clcth (1) having the above-described structure is not suitable for making a protective cover for use on a vehicle that is trailed by a trailer and moving at a high speed.

There are also protective covers made of woven fabrics having waterproof coating to provide waterproof or water-repellent effect. And, to obtain good tensile strength, the woven fabric for making the protective covers must be woven with relatively thick yarns. The thicker the yarns are, the more solid and harder the produced woven fabric is. However, a protective cover made of relatively solid and hard woven fabric tends to frictionally contact with and thereby damage the smooth outer surfaces of the vehicle being protected. The woven fabric for making the protective covers therefore requires improvements for its smooth contact of the vehicle's surface.

The above-mentioned protective cover for covering a vehicle is normally provided along the lower edge at predetermined positions with a plurality of fastening means, so that the protective cover may be fastened to the protected vehicle or to a trailer carrying the vehicle without being lifted or blown off by strong wind. FIG. 3 shows a protective cover (2) has a plurality of loops (21) sewed on the lower edge of cover, so that ropes (3) may be extended through the loops (21) to tie the protective cover (2) to a protected vehicle or a trailer. In the illustrated drawing, the vehicle is a boat (4) supported on a trailer (5). In this way, the protective cover (2) would not be easily blown off or lifted by wind when the boat (4) is positioned or transported on the trailer (5). FIG. 4 is an enlarged perspective view of the circled area A of FIG. 3.

In conclusion, the conventional compound non-woven cloth (1) for making protective cover (2) is waterproof and air-permeable, but has low tensile and tear strength, and the protictive cover (2) made of the compound non-woven cloth (1) tends to break apart at sewed joints (22) of the loops (21) and the cloth (1) when the protective cover (2) covered on and fastened to a protected vehicle or a trailer thereof is subject to strong wind and even turbulent airflow on the way of transporting the vehicle to a certain place at a high speed, and the ropes (3) forcefully pull the loops (21) sewed on the lower edge of the protective cover (2).

### SUMMARY OF THE INVENTION

It is primary object of the present invention to provide a compound fabric for making protective cover to eliminate drawbacks existed in the conventional materials for making the protective cover.

To achieve the above and other objects, the compound fabric of the present invention includes at least three layers of materials. The upper and the lower layer of the compound fabric of the present invention are water-repellent and air-permeable non-woven fabrics made of polypropylene fibers, or polyethylene fibers, or polyester fibers, and the middle layer there of is a woven or knitted fabric having a waterproof and air-permeable resin coating or laminated with a waterproof and air-permeable film. The woven fabric is plain weave, which may be woven from polyester fibers or other synthetic fibers. The knitted fabric is knitted from polyester fibers or other synthetic fibers. The upper and lower layers of non-woven fabrics make the protective cover solid, thick, pliable, water-repellent, and air-permeable, and the middle layer of woven fabric makes the protective cover waterproof, air-permeable, and having enhanced tensile and tear strength. The three layers are bonded together through ultrasonic welding or through adhesive lamination to form a compound fabric that is tough, pliable, waterproof, and air-permeable, there for very suitable for making protective cover.

### BRIEF DESCRIPTION OF THE DRAWINGS

The structure and the technical means adopted by the present invention to achieve the above and other objects can be best understood by referring to the following detailed description of the preferred embondiments and the accompanying drawings, where in

FIG. 1 is a perspective view showing the structure of a conventional compound non-woven fabric for making protective cover;

FIG. 2 is a sectional view of FIG. 1;

FIG. 3 shows a protective cover for covering a boat is provided at a lower edge with a plurality of loops and ropes for tying the protective cover to a trailer;

FIG. 4 is an enlarged view of the circled area A of FIG. 3;

FIG. 5 is a prospective view showing the structure of a compound fabric for making protective cover according to the present invention; and

FIG. 6 is a sectional view of FIG. 5.

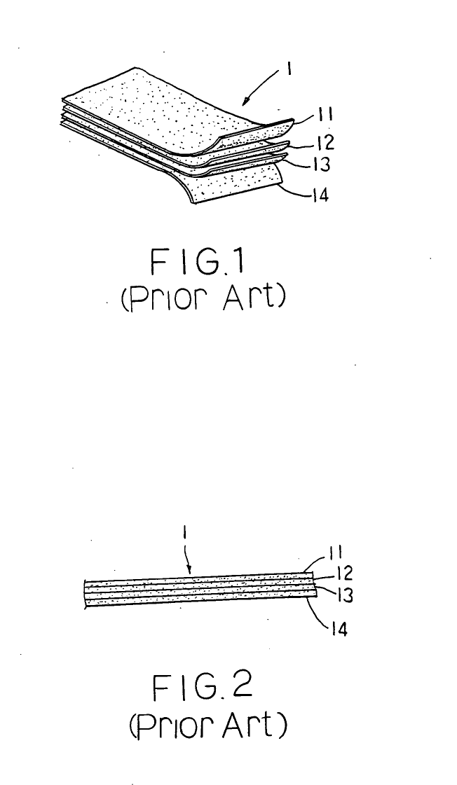

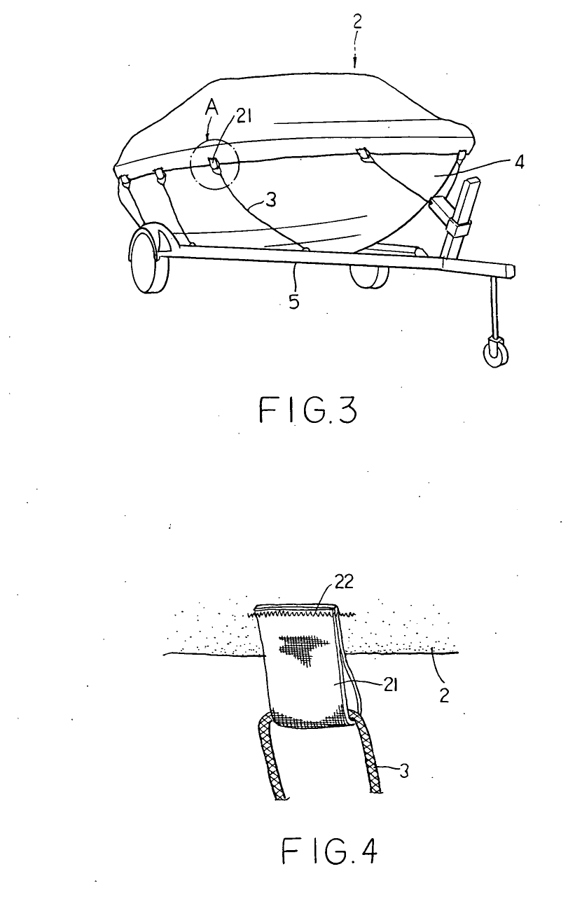

### DETAILED DESCRIPTION OF THE PREFERRED EMBODIMENTS

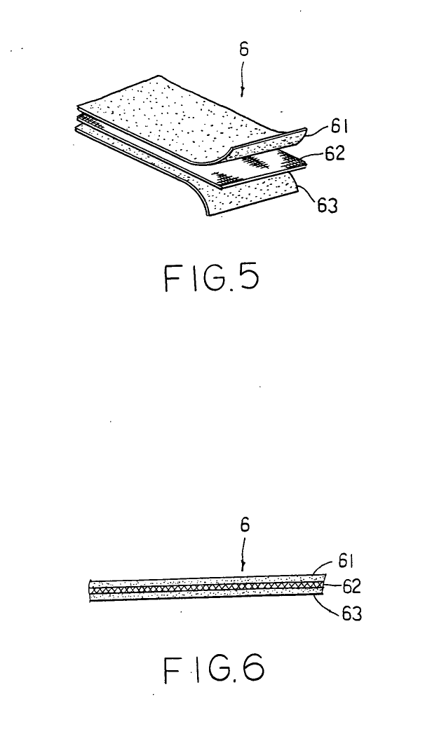

Please refer to FIGS. 5 and 6 that are perspective and sectional views, respectively, showing the structure of a compound fabric (6) for making protective cover according to the present invention.

As shown, the compound fabric (6) includes at least three layers of materials, namely, the upper layer (61), the middle layer (62), and the lower layer (63).

The upper layer (61) is a non-woven fabric made of polypropylene, or polyethylene, or polyester fabers, and includes an ultraviolet absorbent for protecting the fabric from aging due to ultraviolet rays. The non-woven fabric forming the upper layer (61) is also water-repellant and air-permeable. And, the upper layer (61) may include one or more layers of non-woven fabrics.

The middle layer (62) is a woven fabric made of polyester, or polyamide, or other synthetic fibers, and may be of plain weave or knitted weave. The fabric is then coated with a waterproof and air-permeable resin material, such as a Polyurethane (PU) resin, or provided with a waterproof and air-permeable film, such as a PU film. The fabric forming the middle layer (62) may have thickness and structural strength decided by selected thickness of yarns and weaving design or knitting design. It is to be noted the fabric of the middle layer (62) is woven or knitted from continuously extended long fibers and therefore has high tensile strength and high tear strength.

The lower layer (63) is similar to the upper layer (61) and is a non-woven fabric made of polypropylene, or polyethylene, or polyester fibers. Again, the lower (63) may include one or more layer of non-woven fabrics.

The upper layer (61), the middle layer (62), and the lower layer (63), are then bonded together by way of ultrasonic welding or adhesive lamination to form the compound fabric (6).

Due to the non-woven fabrics of the upper layer and the lower layer, (61) and (63), a protective cover made of the compound fabric (6) is pliable, solid, enough thick, and tough without the risk of being scraped and damaged by foreigh matters and/or gravel impacting on the protective cover. On the other hand, the woven fabric of the middle layer (62) compensated the upper and the lower layer, (61) and (63), with its enhanced structural strength, so that the protective cover made of the compound (6) has largely increased tensile and tear strength and is suitable for use not only in a static working environment but also on a trailer moving at a high speed.

Since the protective cover made of the compound fabric of the present invention combines the advantages of the non-woven and the woven fabric to be waterproof and air-permeable having high tensile strength and high tear strength, the protective cover is tough enough to resist a force applied thereto by strong wind and/or turbulent airflow when it is used to cover a vehicle transported on a trailer moving at a high speed. And the risk of having a protective cover torn and broken and the sewed joints (22) of the above-mentioned loops (21) and the lower edge of the protective cover is eliminated. The protective cover may therefore be maintained in good condition under the critical environment to well protect the vehicle being covered.

1. A compound fabric for making protective cover, comprising:
at least one layer of non-woven fabric forming an upper layer of said compound fabric;
a layer of fabric forming the middle layer, which is plain weaving or knitted fabric, of said compound fabric; and
at least one layer of non-woven fabric forming a lower layer of said compound fabric; and
said upper, said middle, and said lower layer being bonded together to form an integral body.

2. The compound fabric for making protective cover as claimed in claim 1, wherein said upper, said middle, and said lower layer are bonded together by way of ultrasonic welding.

3. The compound fabric for making protective cover as claimed in claim 1, wherein said upper, said middle, and said lower layer are bonded together by way of adhesive lamination.

4. The compound fabric for making protective cover as claimed in claim 1, wherein said non-woven fabrics forming said upper and said lower layer are made of polypropylene fibers.

5. The compound fabric for making protective cover as claimed in claim 1, wherein said non-woven fabrics forming said upper and said lower layer are made of polyethylene fibers.

6. The compound fabric for making protective cover as claimed in claim 1, wherein said non-woven fabrics forming said upper and said lower layer are made of polyester fibers.

7. The compound fabric for making protective cover as claimed in claim 1, wherein said woven fabric forming said middle layer is of a plain weave fabric.

8. The compound fabric for making protective cover as claimed in claim 1, wherein said woven fabric forming said middle layer is of a knitted fabric.

9. The compound fabric for making protective cover as claimed in claim 1, wherein said woven fabric is plain weaving fabric forming said middle layer is coated with waterproof and air-permeable resin material.

10. The compound fabric for making protective cover as claimed in claim 1, wherein said knitted fabric forming said middle layer is coated with waterproof and air-permeable resin material.

11. The compound fabric for making protective cover as claimed in claim 9, wherein said resin material is a polyurethane (PU) resin.

12. The compound fabric for making protective cover as claimed in claim 10, wherein said resin material is a polyurethane (PU) resin.

13. The compound fabric for making protective cover as claimed in claim 1, wherein said woven fabric forming said middle layer is laminated with a waterproof and air-permeable film.

14. The compound fabric for making protective cover as claimed in claim 13, wherein said waterproof and air-permeable film is a polyurethane (PU) film.

15. The compound fabric for making protective cover as claimed 1, 7, or 8, wherein said woven fabric forming said middle layer is made of synthetic fibers.

16. The compound fabric for making protective cover as claimed in claim 15, wherein said synthetic fibers are polyester fibers.

17. The compound fabric for making protective cover as claimed in claim 15, wherein said synthetic fibers are polyamide fibers.
